(19) United States
(12) Patent Application Publication
(10) Pub. No.: US 2003/0048974 A1
(43) Pub. Date: Mar. 13, 2003

(54) QUENCHING OF PHASE-MATCHED SURFACE WAVES (SUBSTRATE MODES) IN LINBO3 MODULATORS

(76) Inventor: GANESH K. GOPALAKRISHNAN, BETHESDA, MD (US)

Correspondence Address: MILES & STOCKBRIDGE, P.C., 1751 PINNACLE DRIVE, SUITE 500, MCLEAN, VA, 22102-3833, US

(21) Appl. No.: 09/159,100

(22) Filed: Sep. 23, 1998

(51) Int. Cl. G02B 6/12; B23K 26/00; B29D 11/00

(52) U.S. Cl. 385/14; 219/121.68; 216/24

(57) ABSTRACT

Selective removal of materials from the substrate of an integrated electro-optical device prevents coupling to substrate modes. The selective removal may be accomplished by laser ablation, mechanical removal such as grinding, chemical etching agents, or combinations thereof. The strength of the substrate is maintained by not removing materials from areas where removal is not needed.

### BACKGROUND OF THE INVENTION

The present invention relates to integrated electro-optical devices. More specifically, the present invention relates to a general class of integrated optical devices on LiNb0₃ or other electro-optic material with a buffer layer and a method of making such devices.

In LiNb0₃ optical modulators and other integrated optical devices, the velocity of the electrical-wave must be speeded up to match the velocity of the optical wave to achieve electrical-optical velocity matching.

A drawback associated with the process of engineering the velocity matching is that the electrical mode of the transmission line structure on LiNb0₃ can couple with the substrate modes of the LiNb0₃. These substrate modes are also known as surface waves in microwave terminology. This problem was first observed in LiNb0₃ in 1992, and the solution proposed to circumvent this problem was to thin the LiNb0₃ substrate. This work is archived in the following reference: G. K. Gopalakrishnan, W. K. Burns and C. H. Bulmer, “Electrical Loss Mechanisms in Travelling Wave LiNb0₃ Optical Modulators,” Electronics Letters, Volume 28, No. 2, pages 207-209, 1992.

U.S. Pat. No. 5,416,859 issued May 16, 1995 to Burns, Bulmer, and the present inventor, and hereby incorporated by reference, discloses an optical modulator where coupling to such substrate modes or surface waves are prevented over a given bandwidth. By use of a substrate that has a sufficiently small thickness, coupling between the coplanar mode of the coplanar waveguide electrode structure and any one of the substrate modes is essentially prevented.

In accordance with the research reported in the article mentioned above, the substrate material (LiNb0₃) has to be thinned to obtain high-frequency performance. The higher the frequency of operation, the thinner the substrate has to be to circumvent the problem of coupling to substrate modes.

Thin substrates are easily prone to breaking, and are very difficult to handle, and attach fibers to.

### OBJECTS AND SUMMARY OF THE INVENTION

Accordingly, it is a primary object of the present invention to provide a new and improved integrated optical device and associated method for making such devices.

A more specific object of the present invention is to provide an integrated optical device that avoids or minimizes coupling to substrate modes.

A further object of the present invention is to provide an integrated optical device that minimizes coupling to substrate modes without making substrates prone to breaking, difficult to handle, and difficult attach fibers to.

Yet another object of the present invention is to provide a external optical modulator with improved characteristics.

The above and other features of the present invention which will be more readily understood when the following detailed description is considered in conjunction with the accompanying drawings are realized by an integrated electro-optical device including: a substrate having electro-optical effects with waveguides therein; a plurality of electrodes operable to modulate optical signals in the waveguides; and wherein the substrate has a surface with at least one trough functioning to minimize coupling to substrate modes. Preferably, the integrated electro-optical device of includes a buffer layer. The substrate has a thickness of at least 0.3 mm except that the substrate thickness at the trough is no more than 0.25 mm. In some embodiments, the trough is a channel. In some embodiments, the trough is one of a plurality of troughs that define a line. In some embodiments, the trough extends in a line with different depths at different locations. The substrate has a substrate thickness apart from any trough and the trough has a depth of from 2 percent to 99 percent of the substrate thickness. The substrate has a thickness of at least 0.3 mm except that the substrate thickness at the trough is no more than 0.25 mm and wherein the trough is on a substrate surface that is opposite to a substrate interface with the buffer layer. In some embodiments, the trough is one of a plurality of troughs and all the troughs are channels.

The present invention may alternately be described as a method for making an integrated electro-optical device, the steps including: providing an integrated electro-optical device having: a substrate having electro-optical effects with waveguides therein; and a plurality of electrodes operable to modulate optical signals in the waveguides; and selectively removing substrate material from a substrate surface to create at least one trough functioning to minimize coupling to substrate modes. The providing step uses an integrated electro-optical device that includes a buffer layer. The selective removal is accomplished by applying a laser beam to ablate materials from the substrate. Alternately, the selective removal is accomplished by mechanical removal of materials from the substrate. Alternately, the selective removal is accomplished by chemical etching. The selective removal is performed such that the trough has a depth of from 1 percent to 99 percent of the substrate thickness apart from any trough.

The selective removal is performed such that the substrate has a thickness of at least 0.26 mm except that the substrate thickness at the trough is no more than 0.25 mm and wherein the trough is on a substrate surface that is opposite to a substrate interface with the buffer layer. The selective removal is performed such that the substrate has a thickness of at least 0.3 mm. Prior to the selective removal, the substrate is thinned across its extent. The trough is a channel. The trough is one of a plurality of troughs that define a line.

### BRIEF DESCRIPTION OF THE DRAWINGS

The above and other features of the present invention will be more readily understood when the following detailed description is considered in conjunction with the accompanying drawings wherein like characters represent like parts throughout the several views and in which:

FIG. 1 is a side view of an integrated electro-optical device according to the present invention;

FIG. 2 is a bottom view (i.e., planar to an external substrate surface) of a second embodiment electro-optical device;

FIG. 3 is a bottom view of a part of a third embodiment electro-optical device;

FIG. 4 is a bottom view of a part of a fourth embodiment electro-optical device;

FIG. 5 is a side view of the fourth embodiment;

FIG. 6 is a side view of a fifth embodiment;

FIG. 7 is a side view schematically illustrating a laser process step;

FIG. 8 is a side view schematically illustrating a grinder process step; and

FIG. 9 is a side view schematically illustrating a chemical etching process step.

### DETAILED DESCRIPTION

The present invention allows for the circumvention of the substrate mode coupling problem in LiNb0₃ without having the disadvantages associated with thin substrates.

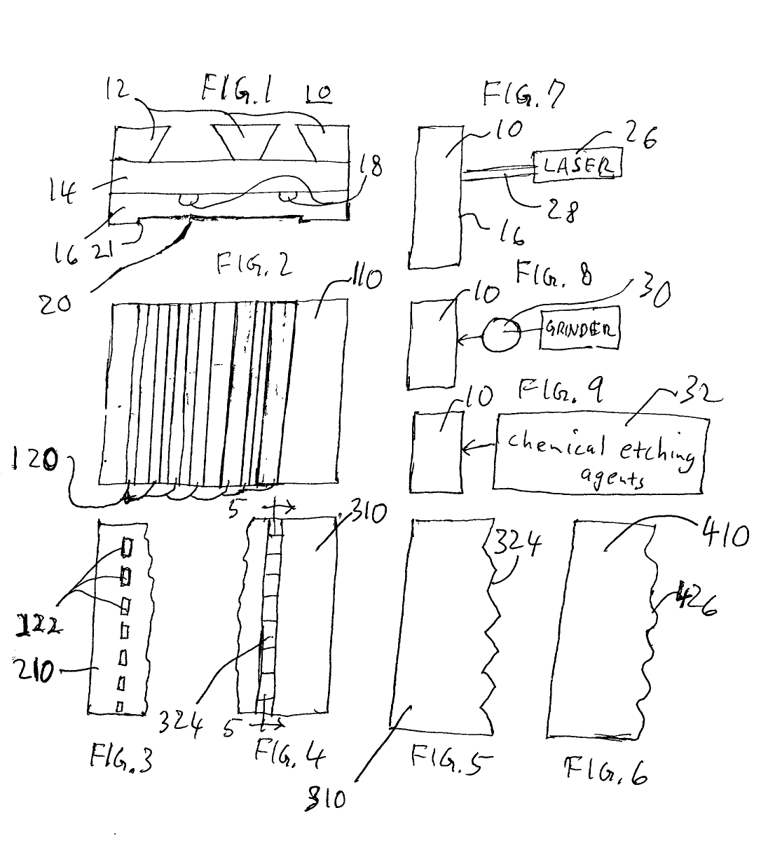

FIG. 1 shows a side view of an optical device 10 having electrodes 12, buffer layer 14, and substrate 16 with waveguides 18 therein. The buffer layer 14 may be fluoropolymer and the substrate 16 may be lithium niobate. If desired, the optical device may be constructed and operate as described in U.S. patent application Ser. No. ______ filed Sep. 16, 1998 in the names of Gopalakrishnan and Singh, titled HIGH-SPEED INTEGRATED OPTICAL DEVICES WITH FLUOROPOLYMER BUFFER LAYER. That application, which is assigned to the assignee of the present application is hereby incorporated by reference. Except as noted, the present design would preferably be constructed and be operable identically with the design of that application. Therefore, the discussion that follows will emphasize features that differ from the design of that application.

Importantly, the substrate 16 has a trough 20 disposed in its external surface (i.e., opposite to the surface facing buffer layer). Preferably, the trough 20 is rectangular or square with sidewalls such as 21 that are perpendicular to the plane of the external surface (thus appearing vertical in the view of FIG. 1). In particular, the troughs are disposed in positions such that they minimize coupling to the substrate modes. In the example shown, the trough is below the center one of electrodes 12 and extends to below the right and left electrodes (ground planes) 12. Advantageously, the troughs allow one to have the thin portions of the substrate in one or more given zones where coupling may occur. At the same time, the substrate is able to maintain most of its mechanical strength. Further, it avoids handling problems and fiber attachment difficulties common to thinner substrates.

As used herein, a trough is any recess in the surface of the substrate or a section of the substrate that is thinner than other portions of the substrate.

With reference to FIG. 2, an alternate device 110 is like device 10 except as noted. (For the embodiments that follow, each device will have 10 as its last two digits and be constructed like 10 of FIG. 1 except as noted.) Instead of the single trough 20, device 110 has a plurality of troughs 120. The troughs 120 are channels that may extend in parallel as shown or crisscross each other or some other configuration. In any case, the troughs 120 effectively simulate a larger trough such as 20 of FIG. 1. In other words, the troughs 120 provide similar prevention or reduction of coupling to substrate modes as the trough 20. (Although not shown, one could alternately have troughs at different locations on the substrate surface.) The channels should be at locations where coupling to substrate modes are dominant. For example, they may be below the center electrode and extends to below the edges of the right and left electrodes as discussed above with respect to FIG. 1. However, other locations may also have troughs.

Turning now to FIG. 3, an alternative to the single trough 20 and channel troughs 120 is illustrated on device 210 as a series of individual troughs 222 that may be collinear. By having the troughs 122 collinear, they may simulate a channel trough 120. Although only one line of troughs 222 is shown, there could be multiple lines of troughs, each line simulating one of the channel troughs 120, and the multiple lines collectively simulating a larger trough like 20. Although not shown, the troughs 222 could be provided in arrangements other than collinear and still provide anti-coupling properties (i.e., prevention or reduction of coupling to substrate modes).

FIGS. 4 and 5 show a device 310 with a sawtooth trough 324 (on the substrate external surface) that may be used in lieu of trough 20 or troughs 120. There could be multiple sawtooth troughs 324 like troughs 120. Alternately, there may be a single sawtooth trough with the width of trough 20 of FIG. 1. FIG. 6 shows a device 410 with a sine wave trough 426 that could be used instead of the trough 20 arrangement. Such trough could be a single trough with the width of trough 20 of FIG. 1 or could be multiple sine wave troughs 426 like troughs 120.

Although the various trough designs could be implemented by creating a substrate having one or more troughs when the substrate is created, the preferable technique is to start with a regular substrate and selectively remove material to create the troughs. The troughs are preferably created in the substrate external surface (i.e., face opposite to the substrate-buffer interface). However, the selective removal could alternately or additionally be performed on the buffer interface surface (the surface shown as horizontal line at top of substrate 16 of device 10 of FIG. 1. Such selective removal could be done before the buffer layer 14 is applied for example. The phase matched coupling to the substrate modes can be quenched by selectively removing regions of LiNb0₃ from the substrate. Thus regions of thin LiNb0₃ are localized to certain sections of the substrate when the coupling is dominant and the substrate retains its thickness at other locations. LiNb0₃ can be selectively removed (from any of the devices 10, 110, 210, 310, and 410) by any of the following approaches:

(I) laser ablation by laser 26 (such as an excimer laser) of FIG. 7 applying a laser beam 28 to ablate material from substrate 16 on device 10 and create troughs;

(ii) mechanical processes such as grinding wheel 30 of FIG. 8;

(iii) chemical etching using agents 32 in FIG. 9. Masking, photolithography, or other techniques may be used to etch in a pattern to create the troughs.

Once the sections of the device where coupling is dominant are identified, then LiNb0₃ can be selectively removed near those regions. The selective removal can use one or more of the techniques of FIGS. 7-9 or other techniques. For example, the troughs could be created by initially using grinder 30 and then using the laser 26 for final adjustment of the troughs.

The present invention may use another approach where the substrate is first thinned across its entire external surface and then one or more troughs are created. For example, if the substrate thickness is initially 0.5 mm troughs can be created in a two step process. First, the substrate is thinned across its entire external surface to bring the substrate down 0.3 mm in thickness. Second, one or more troughs are created in the external surface such that, for example, the substrate thickness at the trough or troughs is brought to 0.2 mm (or at least to 0.25 mm or less). The substrate thickness at locations apart from the troughs will remain at least at 0.3 mm. (More generally, the substrate thickness will be at least 0.26 mm.) Therefore, the substrate will have mechanical strength, ease of handling, and ease of attaching fibers to similar to that of a 0.3 mm thick substrate. At the same time, the coupling to substrate modes is minimized or prevented in similar fashion to operation of a 0.2 mm thick substrate. In other words, the substrate has the advantages (strength, handling ease, and attaching ease) of a relatively thick substrate and has the minimization of coupling to substrate modes of a thin substrate.

The advantage of overall thinning (i.e., thinning the entire substrate) followed by separate trough creation is that the troughs do not need to be made so deep. In the example above a 0.1 mm trough is made, but one does not need to create a 0.3 mm trough because the first 0.2 mm is removed from the entire substrate external surface. The first thinning step can be performed by any of the techniques of FIGS. 7-9 or other removal techniques and the second trough creation step can likewise use any of the techniques of those FIGS. or other removal steps. As used herein, thinning shall refer to thinning a substrate across its entire extent, whereas selective removal shall refer to removing portions of the substrate to create troughs.

The depth of the trough or troughs as a percentage of the substrate thickness (i.e., thickness not in the troughs) is preferably from 1 percent to 99 percent. In other words, if the overall substrate thickness is 1.0 mm, the trough could have a depth of 0.01 mm to 0.99 mm. More preferably, the depth of the substrate is from 10 percent to 90 percent of the substrate thickness. Even more preferably, the substrate depth is from 25 percent to 75 percent of the substrate thickness.

Although specific constructions have been presented herein, it is to be understood that these are for illustrative purposes only. Various modifications and adaptations will be apparent to those of skill in the art. In view of possible modifications, it will be appreciated that the scope of the present invention should be determined by reference to the claims appended hereto.

What is claimed is:

1. An integrated electro-optical device comprising:
a substrate having electro-optical effects with waveguides therein;
a plurality of electrodes operable to modulate optical signals in the waveguides; and
wherein the substrate has a surface with at least one trough functioning to minimize coupling to substrate modes.

2. The integrated electro-optical device of claim 1 further comprising a buffer layer.

3. The integrated electro-optical device of claim 2 wherein the substrate has a thickness of at least 0.3 mm except that the substrate thickness at the trough is no more than 0.25 mm.

4. The integrated electro-optical device of claim 2 wherein the trough is a channel.

5. The integrated electro-optical device of claim 2 wherein the trough is one of a plurality of troughs that define a line.

6. The integrated electro-optical device of claim 2 wherein the trough extends in a line with different depths at different locations.

7. The integrated electro-optical device of claim 2 wherein the substrate has a substrate thickness apart from any trough and the trough has a depth of from 2 percent to 99 percent of the substrate thickness.

8. The integrated electro-optical device of claim 2 wherein the substrate has a thickness of at least 0.3 mm except that the substrate thickness at the trough is no more than 0.25 mm and wherein the trough is on a substrate surface that is opposite to a substrate interface with the buffer layer.

9. The integrated electro-optical device of claim 8 wherein the trough is a channel.

10. The integrated electro-optical device of claim 8 wherein the trough is one of a plurality of troughs that define a line.

11. The integrated electro-optical device of claim 8 wherein the trough is one of a plurality of troughs and all the troughs are channels.

12. A method for making an integrated electro-optical device, the steps comprising:
providing an integrated electro-optical device having: a substrate having electro-optical effects with waveguides therein; and a plurality of electrodes operable to modulate optical signals in the waveguides; and
selectively removing substrate material from a substrate surface to create at least one trough functioning to minimize coupling to substrate modes.

13. The method of claim 12 wherein the providing step uses integrated electro-optical device that includes a buffer layer.

14. The method of claim 12 wherein the selective removal is accomplished by applying a laser beam to ablate materials from the substrate.

15. The method of claim 12 wherein the selective removal is accomplished by mechanical removal of materials from the substrate.

16. The method of claim 12 wherein the selective removal is accomplished by chemical etching.

17. The method of claim 12 wherein selective removal is performed such that the trough has a depth of from 1 percent to 99 percent of the substrate thickness apart from any trough.

18. The method of claim 12 wherein selective removal is performed such that the substrate has a thickness of at least 0.26 mm except that the substrate thickness at the trough is no more than 0.25 mm and wherein the trough is on a substrate surface that is opposite to a substrate interface with the buffer layer.

19. The method of claim 18 wherein selective removal is performed such that the substrate has a thickness of at least 0.3 mm.

20. The method of claim 19 wherein, prior to the selective removal, the substrate is thinned across its extent.

21. The method of claim 12 wherein the trough is a channel.

22. The method of claim 12 wherein the trough is one of a plurality of troughs that define a line.
